(19) United States
(12) Patent Application Publication
(10) Pub. No.: US 2006/0100973 A1
(43) Pub. Date: May 11, 2006

(54) Real-time localized resource extraction

(75) Inventors: Brian L. McMaster, Kirkland, WA (US); Michael Eng, Bellevue, WA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 10/970,262

(22) Filed: Oct. 21, 2004

(51) Int. Cl. G06F 17/30

(52) U.S. Cl. 707/1

(57) ABSTRACT

The subject invention provides a unique system and method that facilitates mitigating the number of versions of a coded application needed to accommodate different spoken languages. The invention involves generating resource tables including resource identifier-resource type pairs. Examples of resource types include strings, bitmaps, icons, menus, and the like. For instance, instead of coding the application with strings, the application is coded with resource identifiers. The strings corresponding to the resource identifiers can be extracted from a resource table and in particular, from a resource file. Before searching through resource files and subdirectories, a cache can be searched to determine whether the resource identifier-string was previously requested. Resource identifiers can be parsed and the relevant information taken therefrom to locate the corresponding strings. If not already in the cache, the resource identifier-string pairs can be cached in a hash table or other database.

### TECHNICAL FIELD

The subject invention relates generally to string data extraction and in particular to the dynamic extraction of resource identifiers to facilitate coding and testing of various applications across different spoken languages.

### BACKGROUND OF THE INVENTION

As a product or application is developed or modified, it may have to undergo various stages of testing to assess its operability and accuracy and to correct any undesirable bugs or operation errors. In general, testing can mitigate user dissatisfaction with the product, thus facilitating a higher quality user experience. One form of testing involves automating the application in the relevant language. Because many products are often offered in several different languages, several different platforms or databases must be maintained by the testers—at least one database per language, for example. In fact, testers traditionally have had to maintain separate hard-coded token files or databases, which included strings as they would appear in the UI of an application.

Unfortunately, this conventional practice is problematic. First, these token files or databases can be very difficult and cumbersome to maintain due to their quantity or size. Second, the strings contained in each database or file often change several times throughout the life of the product; however, the appropriate files or databases may not be consistently updated. As a result, the test may be looking for incorrect or old information in the UI (user interface) of the application, thus causing the test to fail or be considered invalid. Furthermore, testers have been required to write separate tests to cover all the different languages since the token files or databases were hard-coded with the specific string data. Overall, conventional testing processes appear to be error-prone and highly inefficient.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The subject invention relates to a system and/or methodology that facilitate dynamic data extraction and localization of an application particularly when running or testing the application in more than one language. More specifically, the system and method provide a resource extracting mechanism that involves employing resource identifiers that can reference one or more resource tables and that can pull out the desired resource type at run-time. Resource types can include but are not limited to strings or string data, bitmaps, icons, menus, and the like. For example, these resource tables can include a listing of resource identifiers (“resource IDs”) and the string data corresponding to each resource identifier. Rather than hard coding the string data (e.g., “OFF”) directly into the code, the code can instead specify a resource identifier that corresponds to the desired string. As a result, the string itself is not maintained in the code and therefore does not limit the employment of the code to a particular language. Furthermore, the number of applications or tests that would be needed can be substantially reduced to as few as one since it can accommodate and be used in conjunction with any language.

According to one aspect of the invention, the string data can be extracted on the fly or in real-time, since the resource table can be accessed directly to locate the desired resource identifier. Moreover, module names or full path names obtained from directory or sub-directory walks can be cached for future use or reference. This mitigates the need to repeatedly search through sub-directories for a repeatedly requested resource file or ID. Such searches (or walks) can be a rather time-consuming process. Overall, at run-time, files within a coded application or test such an EXE or DLL file, can run properly to mitigate errors and output the language-appropriate results.

According to another aspect of the invention, different resource tables can be generated for each desired language. When working on a machine in a particular language, the resource table in that language can accompany the application. For example, a Spanish-version of the application can include the Spanish-equivalent of the resource table. Thus, when running the application on a Spanish machine, the appropriate string data can accurately appear in the UI of the application.

According to still another aspect of the invention, the string data appearing in the UI, for example, can be verified for its accurateness and overall appearance. For example, if the string “DISPLAY” is meant to be shown at a particular position on the UI, the representation of the string as desired on the UI can be verified. If “DISPLA” is depicted instead of “DISPLAY”, then various parameters can be checked or corrected. Alternatively, if “NEXT PAGE” corresponds to the desired string, then it can be determined whether “NEXT PAGE” or some other string data such as “VIEW” is incorrectly shown. This level of verification can facilitate detecting errors in resource tables and/or error in the code itself.

To the accomplishment of the foregoing and related ends, certain illustrative aspects of the invention are described herein in connection with the following description and the annexed drawings. These aspects are indicative, however, of but a few of the various ways in which the principles of the invention may be employed and the subject invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of a dynamic resource extraction system in accordance with an aspect of the subject invention.

FIG. 2 is a block diagram of an exemplary resource controller that can be used in conjunction with the dynamic resource extraction system of FIG. 1 in accordance with another aspect of the subject invention.

FIG. 3 is a block diagram of exemplary dynamic resource extraction architecture in accordance with yet another aspect of the subject invention.

FIG. 4 is a block diagram of an exemplary interactive media frame display in accordance with still another aspect of the subject invention.

FIG. 5 is a flow chart illustrating an exemplary methodology that facilitates dynamic extraction of resources during run-time in accordance with an aspect of the subject invention.

FIG. 6 is a flow chart illustrating an exemplary methodology that facilitates dynamic extraction of resources during run-time in accordance with an aspect of the subject invention.

FIG. 7 illustrates an exemplary environment for implementing various aspects of the invention.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers.

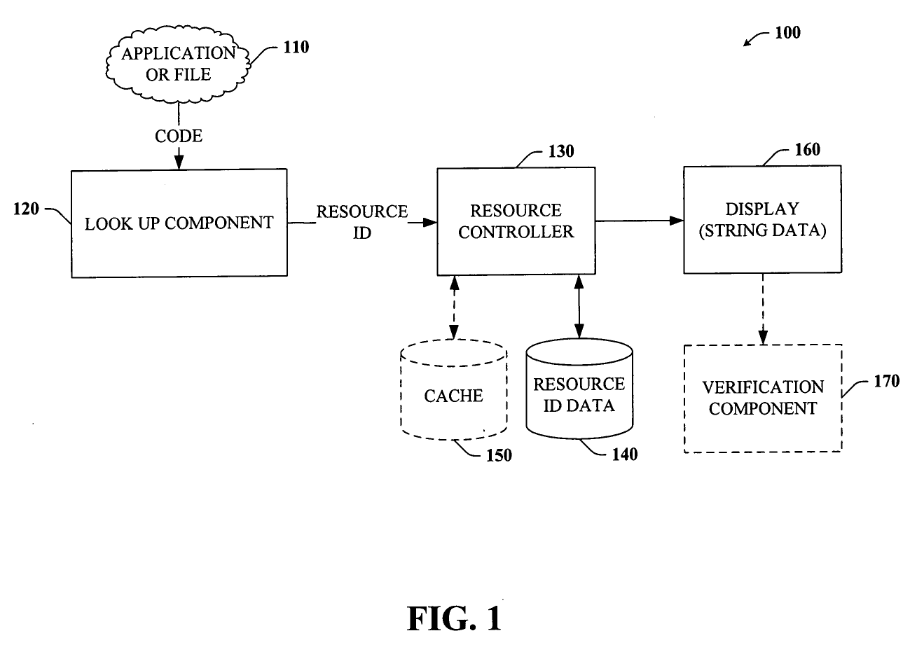

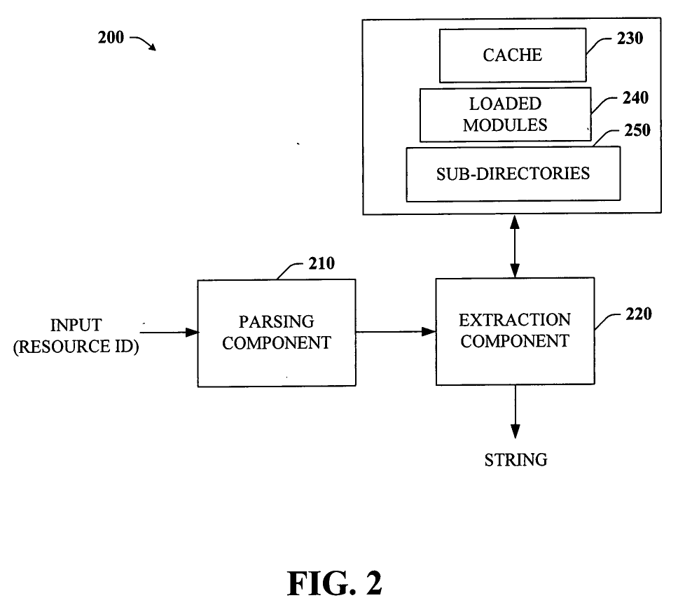

Referring now to FIG. 1, there is a general block diagram of a dynamic resource extraction system 100 in accordance with an aspect of the subject invention. The system 100 includes a coded application or file (e.g., EXE or DLL) 110 that can be run by a user (e.g., tester or developer). The code for the application or file can be written in part by hard-coding resource identifiers in place of one or more various types of resource types such as string data. This may be particularly true for string data or other resource types that differ or vary from one language version of the application to another. As the code is read, a look up component 120 can be employed to locate and/or retrieve any string data corresponding to any resource identifiers that appear in the code. This can be accomplished in part by the look up component communicating the relevant resource ID (as specified in the code) to a resource controller 130. The resource controller can manage or control a resource ID store 130 (e.g., database or table). FIG. 2 provides a more in depth discussion on the resource controller 130.

In general, the resource controller 130 can handle and employ various schemes that may be used to locate or extract the desired string or resource from the resource ID store 140. This can be accomplished in part by parsing the resource identifier to find the correct resource file. Once found, the correct resource or string can be extracted from the resource ID table 140. The resource controller 130 can also save the “resource ID+string” pair a cache 150 or hash table. Moreover, the resource controller can extract this string directly from the cache 150 instead of having to go through the process of finding the file, etc. when the string is requested again. Hence, running the code and obtaining the string data can be performed at a faster pace.

When the resource or string data is obtained, it can be displayed on a display 160 or UI and/or can be verified for its accuracy by a verification component 170. The verification component 170 can check the accuracy of the string in terms of how it is displayed to the user as well as to confirm that the displayed string represents the desired string.

Referring now to FIG. 2, there is illustrated a block diagram of an exemplary resource controller 200 in accordance with an aspect of the subject invention. In particular, the resource controller 200 can be employed in conjunction with the dynamic resource extraction system 100 discussed, supra, in FIG. 1. The resource controller 200 facilitates the dynamic capabilities of the resource extraction system 100 in part by managing the extraction of specific resources or strings from their respective resource identifiers.

The resource controller 200 can include a number of sub-components such as for example, a parsing component 210. The parsing component 210 can receive input, such as a resource ID, which is passed from a look up component. The parsing component 210 can parse the resource identifier to identify and/or read a delimited string that includes information informing the resource controller 200 from where (e.g., which class) to extract the resource. The delimited string can also include one or more parameters that can be passed to an extraction component 220 to carry out the extraction.

The extraction component 220 can assist in searching for a resource file which correlates to the resource ID. The extraction component 220 can access a number of different possible locations to locate the resource file. For example, a cache 230 can be referenced to determine if the resource file (and resource ID) was previously extracted. If the resource file cannot be located in the cache 230, the extraction component 220 can search one or more loaded modules 240 for the target process (under test) as well as one or more sub-directories 250. When the resource file is located, the entire path of the file can be passed to the extraction component 230. In addition to the resource file, a delimited list of parameters needed to extract the resource or string from the file can be passed to the extraction component 230. Once the resource or string is extracted, it can be stored in a hash table together with its resource ID; thereby decreasing extraction time should this resource be requested again.

Alternatively or in addition, the resource controller can take a list of resource types that it should extract and a search path in which the locations where it should search for resource files can be described. The extraction component 230 can then walk the path looking for the needed resource files. In the end, a list of resource ID-resource pairs can be provided as output to a user or tester which can facilitate looking for a resource ID for a particular string in the product under test.

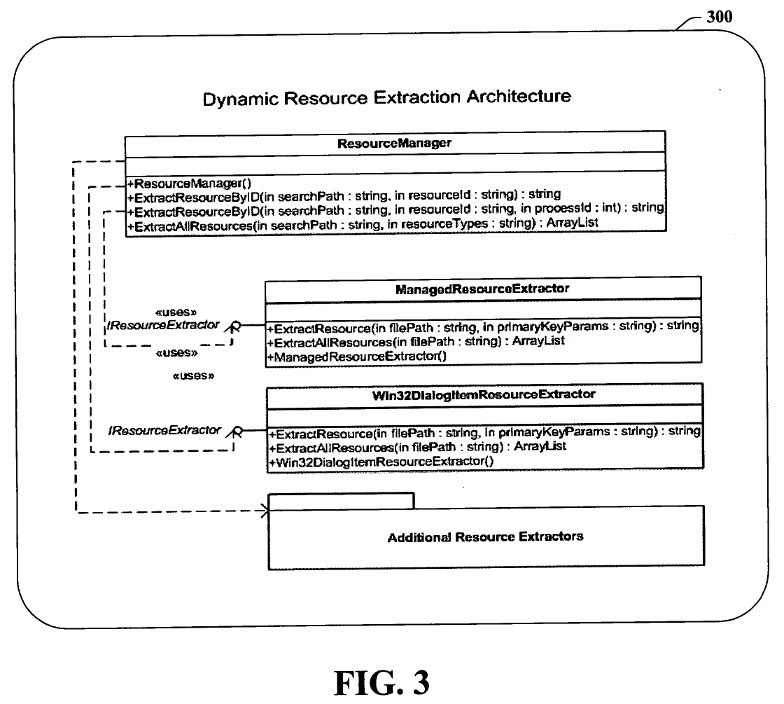

Turning now to FIG. 3, there is illustrated an exemplary dynamic resource extraction architecture 300 in accordance with an aspect of the subject invention. In practice, there can be two parts of the dynamic resource extraction system (e.g., FIG. 1, 100). First, a set of classes can be employed to implement IResourceExtractor. One such IResourceExtractor class can exist for each technology that stores its resources in a different manner. The primary functions on IResourceExtractor are to extract one particular resource from a file, called ExtractResource( ), and to extract all resources of that type in bulk, called ExtractAllResources( ).

The second part of the resource extraction system is the ResourceManager, which is often the primary interface used by client-side code. ResourceManager handles the interactions between all the different IResourceExtractor classes, as well as searching for files to extract the resources from.

The resource manager class has a method called ExtractResourceByID( ). This method takes a search path parameter that is similar to the PATH environment variable, which describes the locations of where to search for resource files. ExtractResourceByID( ) also takes a ResourceIdentifier parameter. The ResourceIdentifier is basically a delimited string that contains information telling the ResourceManager which IResourceExtractor class it should instantiate to extract the resource, as well as the parameters needed to pass to the IResourceExtractor.ExtractResource( ) method to do the extraction. An exemplary ResourceIdentifier string might look like this:
;Cancel;Win32DialogltemString;notepad.exe;11;2.

The first character denotes the delimiter used to parse the string. “Cancel” is the English form of the string we are trying to extract. It should be appreciated that this string is not used by the resource extraction system. It is simply included to have a human-readable part in the resource identifier. “Win32DialogItemString” is the ResourceType, which tells the ResourceManager that it needs to instantiate a Win32DialogItemString IResourceExtractor class to do the extraction. “Notepad.exe” is the file that contains the resource, and the remaining two numbers are the primary key for the Cancel resource within that file. These numbers are used by the Win32DialogItemString's ExtractResource( ) method. Note that depending on the ResourceType, the parameters representing the primary key for the resource can look very different because different technologies use different information to represent the primary key for each resource in a resource file.

After the resource manager's ExtractResourceByID( ) method parses the ResourceIdentifier, the method can begin to search for the resource file. One of the overloads of ExtractResourceByID( ) takes a process identifier parameter. This parameter represents the target process under test. The method uses this parameter to walk the loaded modules of the process. If the resource file is not in the loaded modules of the process, the method uses the search path to find the file. Once the file is found, the method instantiates the IResourceExtractor class, and calls the ExtractResource( ) method, passing it the full path to the file, as well as the delimited list of parameters needed to extract the resource from the file. Once the resource is extracted, the ResourceManager caches this ResourceIdentifier+resource pair in a hash table, for example. Consequently, the next time it is asked to extract this resource, it does not have to find the file and instantiate the IResourceExtractor class, resulting in a much faster extraction of the resource.

The other method on the resource manager class is the ExtractAllResources( ) method. The ExtractAllResources( ) method takes a search path similar to the PATH environment variable in addition to a list of resource types that it should extract. Following, the ExtractAllResources( ) method walks the path looking for resource files. For each resource file, it calls the ExtractAllResources( ) method for every one of the resource types that it was passed. It then compiles all the results and returns a list of resource ID+resource pairs. This comprehensive list of all resources can be helpful to testers when they are looking for the resource identifier for a particular string in the product being tested, for example.

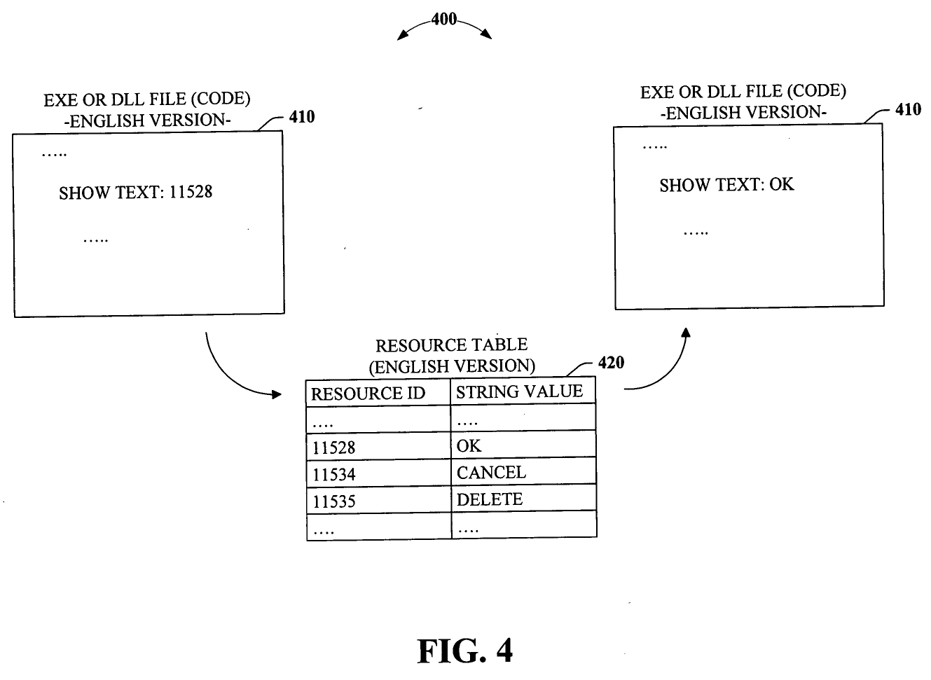

Referring now to FIG. 4, there is illustrated a schematic block diagram of an exemplary dynamic resource extraction mechanism 400 in accordance with an aspect of the subject invention. This diagram may be somewhat over-simplified; however, it conceptually demonstrates at least one aspect of the invention. For example, imagine that an EXE or DLL 410 is running in English and a line of code states:
SHOW TEXT:11528.

The “11528” can refer to a resource identifier that can be found with its corresponding data string in a resource table 420. It should be appreciated that the resource identifier can be any combination of letters, numbers, or a combination of letters and numbers.

The resource table can be linked to the code in such a way that the code knows to look to the resource table to determine which string to plug in to the code. As a result, when the code is run, the string “OK” is inserted or displayed where appropriate in the code.

In conventional coding practices, the line of code would state in English:
SHOW TEXT: OK.

However, when employing the file on different language machines, the string “OK” may not compute. As a result, an error may be returned at run-time. Contrary to conventional coding practices, the subject invention makes use of the resource ID in the code instead of the string. Thus, resource tables can be interchanged depending on where the product or file or application is being used. If the product is being used in Mexico, then the resource table can be built using Spanish. If it is also being sent to Canada, resource tables for English and/or French can be included. Thus, the code for any file or application or product need only be written once as long as the relevant resource tables are built, managed, and kept up to date with respect to a base resource table (e.g., default resource table in English).

Various methodologies in accordance with the subject invention will now be described via a series of acts, it is to be understood and appreciated that the subject invention is not limited by the order of acts, as some acts may, in accordance with the subject invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject invention.

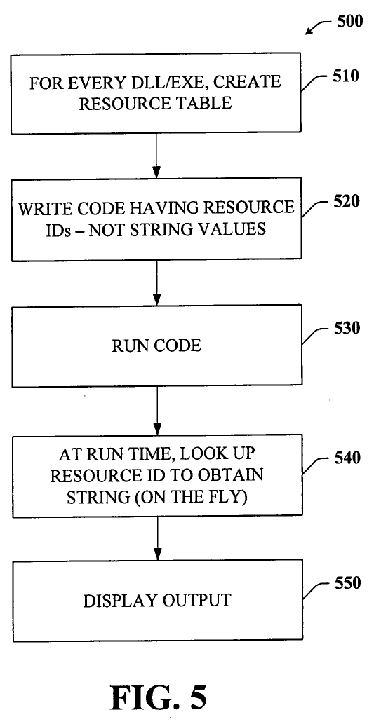

Referring now to FIG. 5, there is a flow diagram of an exemplary process 500 that facilitates dynamic extraction of resources at run-time of any file, application, or product. The process 500 involves creating a resource table for every DLL or EXE file at 510. The resource table may include resource ID+resource pairs of information relevant to the particular DLL or EXE. In conjunction with creating a resource table, code for the file can be written to include resource identifiers (IDs) rather than the exact string values (or any other resource type value) at 520. At 530, the code can be run by a tester for example. At run-time (540), the resource ID can be looked up via the resource table to obtain the string data. This look up process can occur on the fly or in real-time, thus alleviating extra time spent writing multiple versions of the same code to accommodate for different language versions. At 560, the string data can be displayed as output where appropriate.

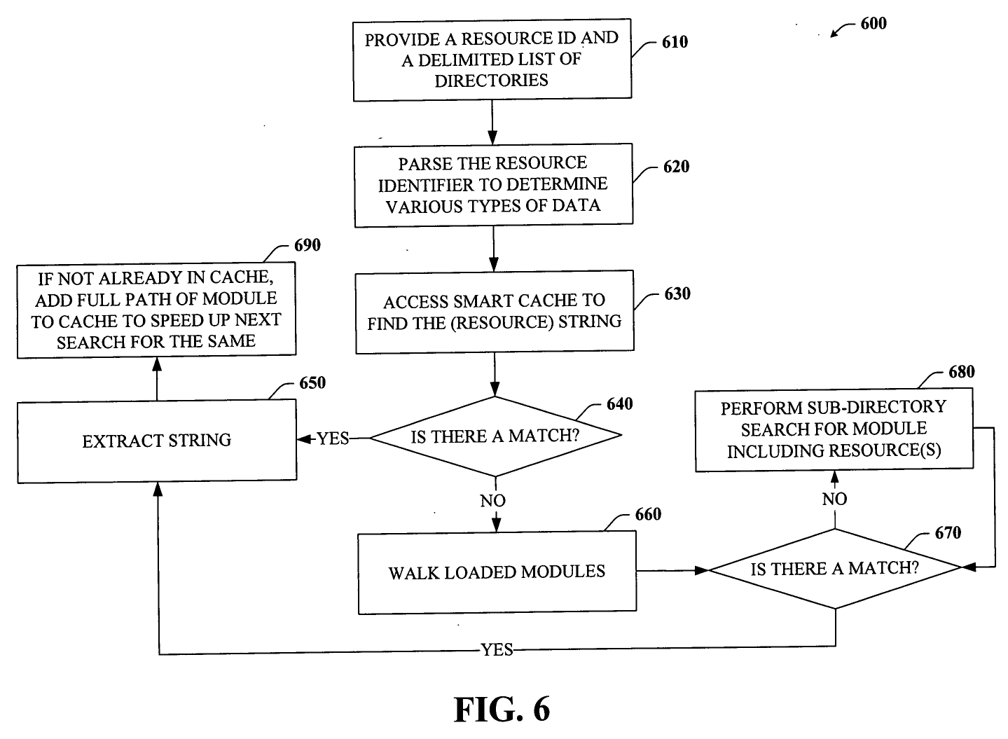

Moving on to FIG. 6, there is illustrated an exemplary process 600 for extracting strings (or any other resource type such as bitmaps, icons, and menus) from the corresponding resource files to facilitate the dynamic extraction of resources in accordance with an aspect of the present invention. There are many different technologies from which strings can be extracted. Each of these technologies can have a different technique of uniquely identifying its strings. A resource extractor's interface (e.g., FIG. 3) provides one method as demonstrated in the process 600. The process 600 involves providing a resource ID and a delimited list of search directories at 610. At 620, the resource ID can be parsed to determine the appropriate technology (e.g., Managed Code strings, Win32 Dialog resources, etc.), module name (that needs to be located), and identifier parameters.

At 630, a smart cache system or component can be accessed initially to ascertain whether the module has already been found (e.g., in a previous extraction process). If a match is found at 640, then the resource can be extracted from the module at 650. However, if no match is located at 640, then the process can walk the loaded modules of the file being run (e.g., product under test) at 660. If the module has still not been located at 670, then the semicolon delimited path can be used to perform a full sub-directory search for the module containing the desired resources. Once the resource or string is found, it can be extracted at 650 and then the module's full path can be added to the cache at 690 to speed up the next search involving the same resource ID or resource file.

Alternatively, a comprehensive listing of resource IDs+resource pairs can be generated. Such a comprehensive list can facilitate testers when they desire to find a resource ID for a particular string in the file or application being tested.

With respect to testing applications, the subject invention can look up strings dynamically in a test instead of storing them in a database. As a result, the various tests can become more robust since they can automatically adapt to string changes or updates. As a further benefit, maintenance costs of tests can be reduced, thereby increasing productivity for testers or users in general as well as leading to quicker time to market for product applications.

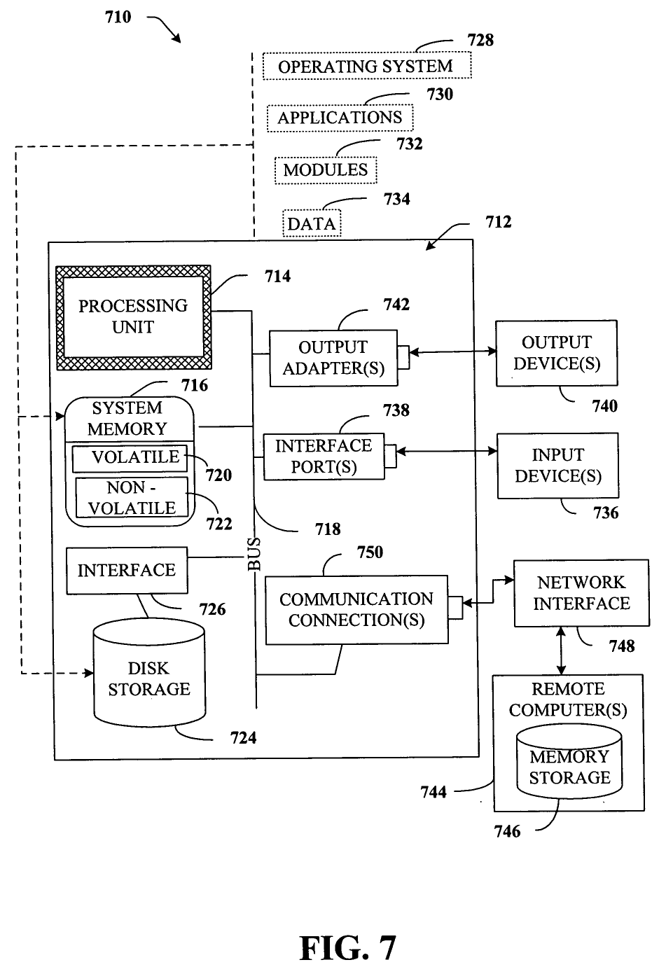

In order to provide additional context for various aspects of the subject invention, FIG. 7 and the following discussion are intended to provide a brief, general description of a suitable operating environment 710 in which various aspects of the subject invention may be implemented. While the invention is described in the general context of computer-executable instructions, such as program modules, executed by one or more computers or other devices, those skilled in the art will recognize that the invention can also be implemented in combination with other program modules and/or as a combination of hardware and software.

Generally, however, program modules include routines, programs, objects, components, data structures, etc. that perform particular tasks or implement particular data types. The operating environment 710 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 7, an exemplary environment 710 for implementing various aspects of the invention includes a computer 712. The computer 712 includes a processing unit 714, a system memory 716, and a system bus 718. The system bus 718 couples system components including, but not limited to, the system memory 716 to the processing unit 714. The processing unit 714 can be any of various available processors. Dual microprocessors and other multiprocessor architectures also can be employed as the processing unit 714.

The system bus 718 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MCA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 716 includes volatile memory 720 and nonvolatile memory 722. The basic input/output system (BIOS), containing the basic routines to transfer information between elements within the computer 712, such as during start-up, is stored in nonvolatile memory 722. By way of illustration, and not limitation, nonvolatile memory 722 can include read only memory (ROM), programmable ROM (PROM), electrically programmable ROM (EPROM), electrically erasable ROM (EEPROM), or flash memory. Volatile memory 720 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 712 also includes removable/nonremovable, volatile/nonvolatile computer storage media. FIG. 7 illustrates, for example a disk storage 724. Disk storage 724 includes, but is not limited to, devices like a magnetic disk drive, floppy disk drive, tape drive, Jaz drive, Zip drive, LS-100 drive, flash memory card, or memory stick. In addition, disk storage 724 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 724 to the system bus 718, a removable or non-removable interface is typically used such as interface 726.

It is to be appreciated that FIG. 7 describes software that acts as an intermediary between users and the basic computer resources described in suitable operating environment 710. Such software includes an operating system 728. Operating system 728, which can be stored on disk storage 724, acts to control and allocate resources of the computer system 712. System applications 730 take advantage of the management of resources by operating system 728 through program modules 732 and program data 734 stored either in system memory 716 or on disk storage 724. It is to be appreciated that the subject invention can be implemented with various operating systems or combinations of operating systems.

A user enters commands or information into the computer 712 through input device(s) 736. Input devices 736 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 714 through the system bus 718 via interface port(s) 738. Interface port(s) 738 include, for example, a serial port, a parallel port, a game port, and a universal serial bus (USB). Output device(s) 740 use some of the same type of ports as input device(s) 736. Thus, for example, a USB port may be used to provide input to computer 712, and to output information from computer 712 to an output device 740. Output adapter 742 is provided to illustrate that there are some output devices 740 like monitors, speakers, and printers among other output devices 740 that require special adapters. The output adapters 742 include, by way of illustration and not limitation, video and sound cards that provide a means of connection between the output device 740 and the system bus 718. It should be noted that other devices and/or systems of devices provide both input and output capabilities such as remote computer(s) 744.

Computer 712 can operate in a networked environment using logical connections to one or more remote computers, such as remote computer(s) 744. The remote computer(s) 744 can be a personal computer, a server, a router, a network PC, a workstation, a microprocessor based appliance, a peer device or other common network node and the like, and typically includes many or all of the elements described relative to computer 712. For purposes of brevity, only a memory storage device 746 is illustrated with remote computer(s) 744. Remote computer(s) 744 is logically connected to computer 712 through a network interface 748 and then physically connected via communication connection 750. Network interface 748 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 750 refers to the hardware/software employed to connect the network interface 748 to the bus 718. While communication connection 750 is shown for illustrative clarity inside computer 712, it can also be external to computer 712. The hardware/software necessary for connection to the network interface 748 includes, for exemplary purposes only, internal and external technologies such as, modems including regular telephone grade modems, cable modems and DSL modems, ISDN adapters, and Ethernet cards.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A dynamic resource extraction system comprising:
a look up component that receives and looks up a resource identifier from an application code in real-time; and
a resource controller that analyzes the resource identifier to facilitate locating any one of its resource file and identifier parameters to find the resource type corresponding to the resource identifier in real-time.

2. The system of claim 1, the resource controller comprising:
a parsing component that parses information from the resource identifier to ascertain where to find the resource file and desired resource type; and
an extraction component that searches one or more locations and extracts the string from the resource file when found.

3. The system of claim 2, the information comprising at least one of a resource type, a module name or resource file name, and one or more identifier parameters.

4. The system of claim 2, the one or more locations comprises a cache, one or more loaded modules, and one or more sub-directories.

5. The system of claim 2, the resource type comprising at least one of string data, bitmap, icon, and menu.

6. The system of claim 1, further comprising a cache that stores one or more identified resource identifier-resource type pairs.

7. The system of claim 6, the cache can be accessed by the resource controller to save time when looking for a resource type that has been previously extracted or for a module that has already been found with a directory walk.

8. The system of claim 6, the cache is located on a local machine.

9. The system of claim 1, the look up component communicates with a file or application under test at run-time to obtain the resource identifier.

10. The system of claim 1, the resource identifier is interchangeable between any machines in any language thereby allowing the application code to run in more than one spoken language along with at least one language-specific resource table.

11. The system of claim 1, further comprising one or more resource tables that are generated for and coupled to each respective application code to facilitate dynamic extraction of string data at run-time from the resource table and into the application code.

12. The system of claim 11, the resource tables comprise resource identifier-string pairs.

13. The system of claim 11, wherein any one resource table is maintained in a plurality of different languages.

14. The system of claim 1, further comprising a verification component that verifies whether the resource type extracted from the resource file is correct.

15. A method that facilitates dynamic resource extraction comprising:
writing an application code with resource identifiers in place of corresponding resource types; and
looking up the resource identifiers in at least one resource table to locate the corresponding resource types in real-time.

16. The method of claim 15, the resource types comprises at least one of the following: string data, bitmap, icon, and menu.

17. The method of claim 15, further comprising:
parsing the resource identifiers to facilitate determining where to locate the corresponding resource types; and
extracting the corresponding resource types when found in real-time to facilitate a proper running of the application code.

18. The method of claim 15, looking up the resource identifiers comprises:
employing a process identifier parameter parsed from the resource identifier, wherein the process identifier represents a process under test;
walking through one or more loaded modules of the process using the process identifier parameter;
locating a resource file associated with at least one resource identifier; and
passing the resource file by its full path name to an extraction component to extract the resource type from the resource file.

19. The method of claim 15, looking up the resource identifiers comprises generating a comprehensive list of substantially all resource types to facilitate a user in finding a desired resource identifier for a particular resource type in the application.

20. The method of claim 15, further comprising caching identified resource identifier-resource type pairs to mitigate search time when a similar search is requested again.

21. The method of claim 15, further comprising verifying that the resource type extracted from the resource table is correct.

22. The method of claim 15, further comprising generating the resource table in multiple languages, the resource table comprising resource identifier-resource type pairs, to mitigate writing multiple language versions for the same application code.

23. A data packet adapted to be transmitted between two or more computer processes facilitating extracting resources in a dynamic manner at run-time of application code, the data packet comprising: information associated with a resource identifier coded in an application and a look up of the resource identifier into a resource table to extract a corresponding string to yield desired output of information during run-time of the application.

24. A computer readable medium having stored thereon the computer executable components of the system of claim 1.

25. A dynamic resource extraction system comprising:
means for writing an application code with resource identifiers in place of corresponding strings; and
means for looking up the resource identifiers in at least one resource table to locate the corresponding strings in real-time.

26. The system of claim 25, further comprising:
means for parsing the resource identifiers to facilitate determining where to locate the corresponding strings; and
means for extracting the corresponding strings when found in real-time to facilitate a proper running of the application code.
